(19) United States
(12) Patent Application Publication
(10) Pub. No.: US 2013/0100381 A1
(43) Pub. Date: Apr. 25, 2013

(54) BACKLIGHT MODULE AND LIQUID CRYSTAL DISPLAY DEVICE

(71) Applicants: Chechang Hu, Shenzhen (CN); Hu He, Shenzhen (CN)

(72) Inventors: Chechang Hu, Shenzhen (CN); Hu He, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/378,044

(22) PCT Filed: Nov. 15, 2011
(86) PCT No.: PCT/CN2011/082189

§ 371 Date: Dec. 13, 2011

(30) Foreign Application Priority Data
Oct. 25, 2011 (CN) 201110327162.2

(51) Int. Cl. G02F 1/13357; F21V 7/04

(52) U.S. Cl. 349/65; 362/609

(57) ABSTRACT

The present invention provides a backlight module, which comprises a light guide plate and a light source. The light guide plate comprises a light input side, a light output surface which adjoins to the light input side, and a bottom surface corresponding to the light output surface. The light source comprising a light-emitting surface is disposed at one side of the light input side of the light guide plate, and the light-emitting surface of the light source is corresponding to the light input side of the light guide plate. The backlight module further comprises a specular reflector which is disposed between the light-emitting surface of the light source and the light input side of the light guide plate. Light beams which are emitted from the light-emitting surface of the light source toward the outside of the light guide plate will enter the light guide plate after being specularly reflected by the specular reflector. The present invention further provides a liquid crystal display device.

### FIELD OF THE INVENTION

The present invention relates to a scope of a liquid crystal display device, and more particularly to a backlight module and a liquid crystal display device.

### BACKGROUND OF THE INVENTION

With the development of the liquid crystal display technology, people have higher and higher functional requirements in the liquid crystal display.

Referring to FIG. 1, a partially structural view of a traditional backlight module is illustrated. The backlight module comprises a light source 11 and a light guide plate 12, wherein the light source 11 may be a light-emitting diode (LED) for emitting light beams. The light beams emitted by the light source 11 enter the light guide plate 12, wherein a coupling efficiency between the light source 11 and the light guide plate 12 is directly relative to a luminous utilization of the whole backlight module.

The traditional light source 11 generally adopts an LED with a similar Lambertian-type. This kind of the LED has a characteristic with the low voltage and high luminous-flux. The light beams emitted by the Lambertian-type LED mainly concentrate in an angle which faces the light guide plate 12. While the angle is larger than a certain extent, the light beams within the angle may be relatively reduced.

In a case of an LED package for the 5630 model, which has a package size of 5.6 mm×3.0 mm×0.8 mm, the luminous-flux of the LED package at various viewing angles in horizontal and vertical directions are measured. It will be measured that the viewing angle at about 60-degree, the luminous-flux has been reduced to half. Apparently, the larger viewing angle has the smaller relative proportion of the luminous-flux, wherein the luminous-flux is an illuminating proportion of the light source 11.

Moreover, a distance between a light-emitting surface 111 of the light source 11 and a light input side 121 of the light guide plate 12 is 2.4 mm. If the distance is smaller, a leakage proportion of light beams may be decreased.

Please refer to FIGS. 2A to 2B, comparative schematic views of leakage proportions of the light beams in different distances D1 and D2 are illustrated in FIGS. 2A to 2B, wherein D1>D2. Apparently, in a situation of the unchanged model of the light source 11, the larger leakage angle of the light beams has the larger leakage proportion of the light beams in the situation of distance D1, and the smaller leakage angle of the light beams has the smaller leakage proportion of the light beams in the situation of distance D2.

However, considering a character of thermal expansion of the light guide plate 12, a certain space has to be reserved between the light source 11 and the light guide plate 12, so that the light guide plate 12 may have an expansible space.

Please refer to FIG. 3, for solving problems of loss light beams induced by the space between the light source 11 and the light guide plate 12, a white reflector 13 is generally disposed between the light source 11 and the light guide plate 12, so that light beams which may be emitted toward the outside of the light guide plate 12 are reflected back to the light guide plate 12 by the white reflector 13.

But, because of the white reflector 13 has a character of light scattering, the white reflector 13 will scatter the light beams to various angles after being emitting toward the white reflector 13. Finally, only the limited light beams are gathered into the light guide plate 12, so as to reduce the luminous utilization of the backlight module and affect a light-emitting effect of the backlight module, resulting in affecting the quality of images of the liquid crystal display device.

### SUMMARY OF THE INVENTION

An object of the present invention is to provide a backlight module for solving the technical problems of the white reflector of the traditional technology that cannot effectively reflect the light beams which are emitted from the light source toward the outside of the light guide plate to enter the light guide plate resulting in reducing the luminous utilization of the backlight module and affecting the display quality of a liquid crystal display device.

For solving the above problems, the present inventor provides a backlight module which comprises a light guide plate and a light source. The light guide plate comprises a light input side, a light output surface which adjoins to the light input side, and a bottom surface which is corresponding to the light output surface. The light source comprises a light-emitting surface which is disposed at one side of the light input side of the light guide plate, and the light-emitting surface of the light source is corresponding to the light input side of the light guide plate.

The backlight module further comprises a specular reflector which extends along a reflecting plane; and the reflecting plane and the light input side of the light guide plate form a predetermined angle therebetween. The light-emitting surface of the light source and the light input side of the light guide plate have a coupling-light distance therebetween, and the coupling-light distance is ranged within a coupling-light range between 0.1 millimeter and 2.5 millimeter.

The specular reflector is disposed between the light-emitting surface of the light source and the light input side of the light guide plate. Light beams which are emitted from the light-emitting surface of the light source toward the outside of the light input side of the light guide plate enter the light guide plate after being specularly reflected by the specular reflector.

In the backlight module of the present invention, a coupling-light area is formed between the light-emitting surface of the light source and the light input side of the light guide plate. The specular reflector is disposed at an adjoining region of the coupling-light area and the light output surface of the light guide plate, and the reflecting plane is perpendicular to the light input side of the light guide plate, wherein the predetermined angle is a right angle.

In the backlight module of the present invention, the specular reflector is a silver reflector.

A secondary object of the present invention is to provide a backlight module for solving the technical problems of the white reflector of the traditional technology that cannot effectively reflect the light beams which are emitted from the light source toward the outside of the light guide plate to enter the light guide plate resulting in reducing the luminous utilization of the backlight module and affecting the display quality of a liquid crystal display device.

For solving the above problems, the present inventor provides a backlight module which comprises a light guide plate and a light source. The light guide plate comprises a light input side, a light output surface which adjoins to the light input side, and a bottom surface which is corresponding to the light output surface. The light source comprises a light-emitting surface which is disposed at one side of the light input side of the light guide plate, and the light-emitting surface of the light source is corresponding to the light input side of the light guide plate.

The backlight module further comprises a specular reflector, which is disposed between the light-emitting surface of the light source and the light input side of the light guide plate. Light beams which are emitted from the light-emitting surface of the light source toward the outside of the light input side of the light guide plate enter the light guide plate after being specularly reflected by the specular reflector.

In the backlight module of the present invention, the specular reflector extends along a reflecting plane, and the reflecting plane and the light input side of the light guide plate form a predetermined angle therebetween.

In the backlight module of the present invention, a coupling-light area is formed between the light-emitting surface of the light source and the light input side of the light guide plate. The specular reflector is disposed at an adjoining region of the coupling-light area and the light output surface of the light guide plate, and the reflecting plane is perpendicular to the light input side of the light guide plate, wherein the predetermined angle is a right angle.

In the backlight module of the present invention, the specular reflector is a silver reflector.

In the backlight module of the present invention, the light-emitting surface of the light source and the light input side of the light guide plate have a coupling-light distance therebetween, and the coupling-light distance is ranged within a coupling-light range between 0.1 millimeter and 2.5 millimeter.

A third object of the present invention is to provide a liquid crystal display device for solving the technical problems of the white reflector of the traditional technology that cannot effectively reflect the light beams which are emitted from the light source toward the outside of the light guide plate to enter the light guide plate resulting in reducing the luminous utilization of the backlight module and affecting the display quality of the liquid crystal display device.

For solving the above problems, the present inventor provides a liquid crystal display device comprises a liquid crystal display panel. The liquid crystal display device further comprises a backlight module which comprises a light guide plate and a light source. The light guide plate comprises a light input side, a light output surface which adjoins to the light input side, and a bottom surface which is corresponding to the light output surface. The light source comprises a light-emitting surface which is disposed at one side of the light input side of the light guide plate, and the light-emitting surface of the light source is corresponding to the light input side of the light guide plate.

The backlight module further comprises a specular reflector, which is disposed between the light-emitting surface of the light source and the light input side of the light guide plate. Light beams which are emitted from the light-emitting surface of the light source toward the outside of the light input side of the light guide plate enter the light guide plate after being specularly reflected by the specular reflector.

In the liquid crystal display device of the present invention, the specular reflector extends along a reflecting plane, and the reflecting plane and the light input side of the light guide plate form a predetermined angle therebetween.

In the liquid crystal display device of the present invention, a coupling-light area is formed between the light-emitting surface of the light source and the light input side of the light guide plate. The specular reflector is disposed at an adjoining region of the coupling-light area and the light output surface of the light guide plate, and the reflecting plane is perpendicular to the light input side of the light guide plate, wherein the predetermined angle is a right angle.

In the liquid crystal display device of the present invention, the specular reflector is a silver reflector.

In the liquid crystal display device of the present invention, the light-emitting surface of the light source and the light input side of the light guide plate have a coupling-light distance therebetween, and the coupling-light distance is ranged within a coupling-light range between 0.1 millimeter and 2.5 millimeter.

Comparing to the existing technology, the present invention solves the technical problems of the white reflector of the existing technology that cannot effectively reflect the light beams which are emitted from the light source toward the outside of the light guide plate to enter the light guide plate resulting in reducing the luminous utilization of the backlight module, so that the display quality of a liquid crystal display device may be enhanced.

The foregoing contents adopted by the present invention can be best understood by referring to the following detailed description of the preferred embodiments and the accompanying drawings:

### DESCRIPTION OF THE DRAWINGS

FIG. 1 is a partially structural view of a traditional backlight module;

FIGS. 2A to 2B are comparative schematic views of leakage proportions of light beams in different distances between the traditional light source and light guide plate;

FIG. 3 is a partially structural view of the traditional backlight module;

FIG. 4 is a schematic structural view of a preferred embodiment of a backlight module of the present invention;

FIG. 5 is a schematic view of the preferred embodiment of connecting a specular reflector with a light guide plate in the backlight module of the present invention; and

FIG. 6 is a comparative diagram of coupling value of the specular reflector of the present invention and coupling efficiency in other situations.

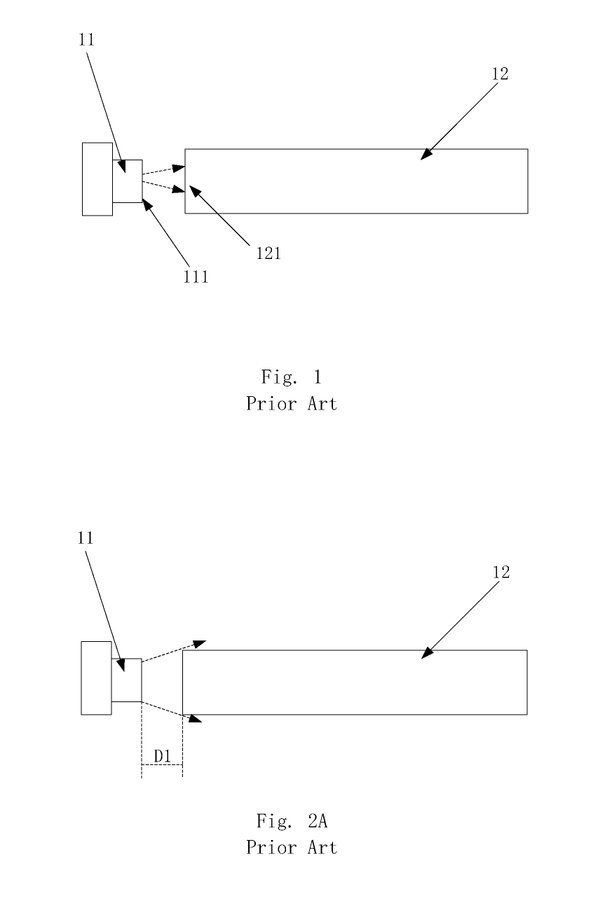

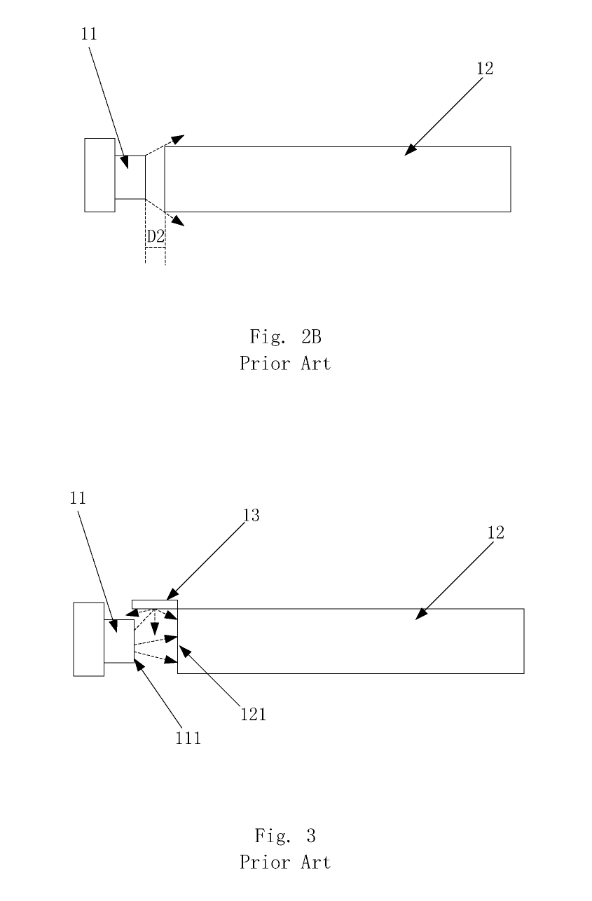

### DETAILED DESCRIPTION OF THE PREFERRED EMBODIMENTS

The foregoing description of embodiments is referring to the accompanying drawings for description of the specific embodiments which can be carried out in the present invention.

FIG. 4 is a schematic structural view according to a preferred embodiment of a backlight module of the present invention, and the backlight module comprises a light guide plate 41 and a light source 42.

Please refer to FIG. 4, the light guide plate 41 comprises a light input side 411, a light output surface 412 which adjoins to the light input side 411, and a bottom surface 413 which is corresponding to the light output surface 412. The light source 42 is disposed at one side of the light input side 411 of the light guide plate 41, and the light source 42 comprises a plurality of LED. Resin of each LED comprises a light-emitting surface 421, and light beams which are emitted from the light-emitting surface 421 of the light source 42 toward the light input side 411 of the light guide plate 41. A coupling-light area 43 is formed between the light-emitting surface 421 of the light source 42 and the light input side 411 of the light guide plate 41.

In this preferred embodiment, the light-emitting surface 421 of the light source 42 and the light input side 411 of the light guide plate 41 have a coupling-light distance D therebetween, wherein the coupling-light distance D is ranged within a predetermined coupling-light range. For example, the predetermined coupling-light range is greater than 0.1 mm and less than 2.5 mm, and the coupling-light distance D is 1.0 mm.

In this embodiment, the backlight module further comprises a specular reflector 44. The specular reflector 44 is disposed between the light-emitting surface 421 of the light source 42 and the light input side 411 of the light guide plate 41, wherein the specular reflector 44 uses to generate specular reflection. The light beams which are emitted from the light-emitting surface 421 of the light source 42 toward the outside of the light input side 411 of the light guide plate 41 enter the light guide plate 41 after being specularly reflected by the specular reflector 44.

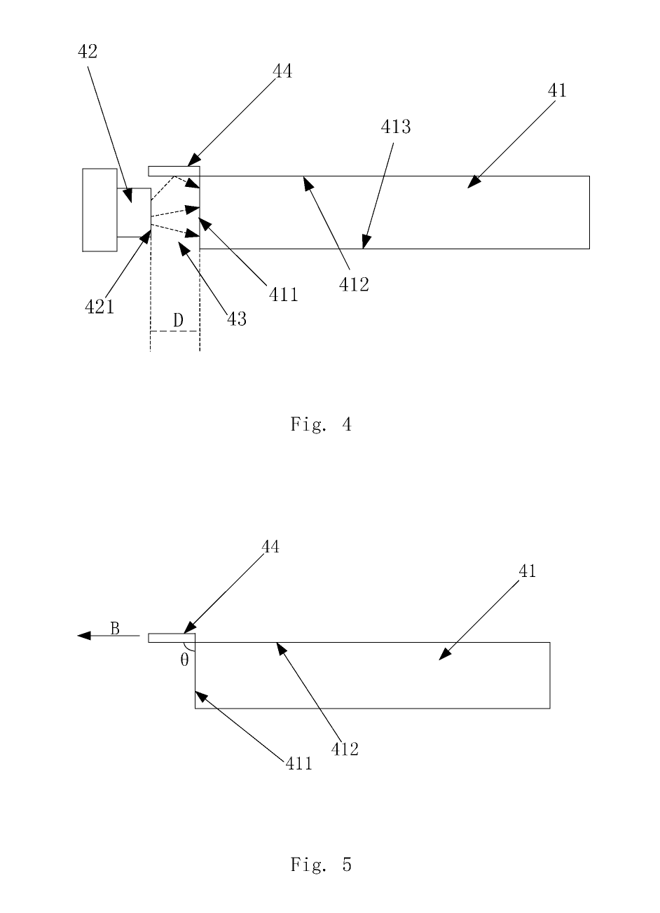

Please refer to FIG. 5, the specular reflector 44 extends along a reflecting plane B, and the reflecting plane B and the light input side 411 of the light guide plate 41 form a predetermined angle θ therebetween.

In the embodiment shown in FIG. 4, the specular reflector 44 is disposed at an adjoining region of the coupling-light area 43 and the light-emitting surface 421 of the light source 42, and the reflecting plane B is perpendicular to the light input side 411 of the light guide plate 41. Of course, during the specifically implementing process, the specular reflector 44 also may be disposed on other positions of the coupling-light area 43 or outside of the coupling-light area 43, as long as the specular reflector 44 shall specularly reflect the light beams emitted from the light source 42 toward the outside of the light guide plate 41 beck to the light guide plate 41. Here will not to enumerate one by one.

Referring to FIG. 5, in this embodiment, the predetermined angle θ is 90-degree. Of course, it can be other predetermined degrees, as long as the light beams emitted toward the specular reflector 44 shall enter the light guide plate 41 after being specularly reflected by the specular reflector 44. Here will not to enumerate one by one.

Wherein, when the predetermined angle θ is 90-degree, a coupling value which the specular reflector 44 couples the light beams emitted by the light source 42 is greater than a predetermined coupling value, and the coupling value is a proportion of specularly reflecting the light beams to enter the light guide plate 41. For example, when a viewing angle is 60-degree and the predetermined angle θ is set 90-degree, the proportion of the specular reflector 44 specularly reflects the light beams which the light source 42 emits toward the specular reflector 44 to enter the light guide plate 41 is greater than 70%.

The preferred choice is that the specular reflector 44 is a silver reflector, and of course it may be other material reflector, as long as what can make the specular reflection for the light beams to be emitted toward the specular reflector 44. Here will not to enumerate one by one.

The principle of the preferred embodiment of the backlight module of the present invention is:

Please refer to FIGS. 4 to 5, during light-emitting processes of the backlight module, parts of the light beams emitted from the light-emitting surface 421 of the light source 42 directly enter the light input side 411 of the light guide plate 41, and other parts are emitted the outside of the light input side 411 of the light guide plate 41. Referring to FIG. 4, the specular reflector 44 will specularly reflect the light beams emitted toward the specular reflector 44 according as positing the specular reflector 44 on the coupling-light area 43. Thus, the light beams emitted toward the specular reflector 44 will enter the light guide plate 41 after specularly reflecting by the specular reflector 44.

Moreover, because of the light beams emitted toward the specular reflector 44 only can occur to the specular reflection, elastically disposing the predetermined angle θ may let the light beams emitted toward the specular reflector 44 all be specularly reflected to the light guide plate 41.

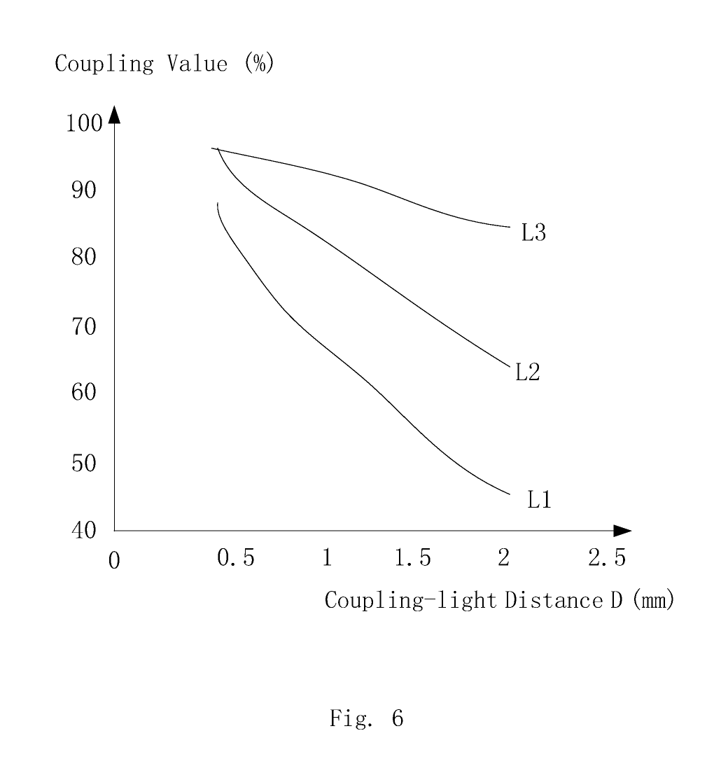

Please refer to FIG. 6, which is a comparative diagram of corresponding couplings in three situations of different coupling distances, wherein L1 is the coupling is disposed with no any reflector, L2 is the coupling of adopting a white reflector, and L3 is the coupling of adopting the specular reflector 44 of the embodiment of the present invention.

Evidently, because of the specular reflector 44 provides the specular reflection, it shall ensure that the light beams emitted toward the specular reflector 44 only can occur to specularly reflect and then enter the light guide plate 41. Thus, it may promise the higher coupling and greatly improve the luminous utilization, thereby upgrading the image displaying quality of a liquid crystal display device.

The present invention also provides a liquid crystal display device, which comprises a liquid crystal display panel. The liquid crystal display further comprises the backlight module of the present invention, and the backlight module is connected to the liquid crystal display panel, and the light beams which are emitted from the backlight module enter the liquid crystal display panel. Because of the backlight module has been detailed description in the above, here will no longer redundancy.

In summary, when the present invention has been described in terms of a preferred embodiment thereof, it is to be understood that the invention is not limited thereto. Other skilled in this art may change and modification to the described embodiment without departing from the true scope and the spirit of the invention that is intended to be limited only by the appended claims.

What is claimed is:

1. A backlight module comprising: a light guide plate and a light source, the light guide plate comprising a light input side, a light output surface which adjoins to the light input side, and a bottom surface corresponding to the light output surface; wherein the light source comprising a light-emitting surface is disposed at one side of the light input side of the light guide plate, and the light-emitting surface of the light source is corresponding to the light input side of the light guide plate, characterized in that:
the backlight module further comprises: a specular reflector, which extends along a reflecting plane, and the reflecting plane and the light input side of the light guide plate have a predetermined angle therebetween; the light-emitting surface of the light source and the light input side of the light guide plate have a coupling-light distance therebetween, and the coupling-light distance is ranged within a coupling-light range between 0.1 millimeter and 2.5 millimeter; and
wherein the specular reflector is disposed between the light-emitting surface of the light source and the light input side of the light guide plate; and light beams which are emitted from the light-emitting surface of the light source toward an outside of the light input side of the light guide plate enter the light guide plate after being specularly reflected by the specular reflector.

2. The backlight module according to claim 1, characterized in that: a coupling-light area is formed between the light-emitting surface of the light source and the light input side of the light guide plate, the specular reflector is disposed at an adjoining region of the coupling-light area and the light output surface of the light guide plate, and the reflecting plane is perpendicular to the light input side of the light guide plate, wherein the predetermined angle is a right angle.

3. The backlight module according to claim 1, characterized in that: the specular reflector is a silver reflector.

4. A backlight module comprising: a light guide plate and a light source, the light guide plate comprising a light input side, a light output surface which adjoins to the light input side, and a bottom surface corresponding to the light output surface; wherein the light source comprising a light-emitting surface is disposed at one side of the light input side of the light guide plate, and the light-emitting surface of the light source is corresponding to the light input side of the light guide plate, characterized in that:
the backlight module further comprises: a specular reflector, which is disposed between the light-emitting surface of the light source and the light input side of the light guide plate, and light beams which are emitted from the light-emitting surface of the light source toward an outside of the light input side of the light guide plate enter the light guide plate after being specularly reflected by the specular reflector.

5. The backlight module according to claim 4, characterized in that: the specular reflector extends along a reflecting plane, and the reflecting plane and the light input side of the light guide plate form a predetermined angle therebetween.

6. The backlight module according to claim 5, characterized in that: a coupling-light area is formed between the light-emitting surface of the light source and the light input side of the light guide plate, the specular reflector is disposed at an adjoining region of the coupling-light area and the light output surface of the light guide plate, and the reflecting plane is perpendicular to the light input side of the light guide plate, wherein the predetermined angle is a right angle.

7. The backlight module according to claim 4, characterized in that: the light-emitting surface of the light source and the light input side of the light guide plate have a coupling-light distance therebetween, and the coupling-light distance is ranged within a coupling-light range between 0.1 millimeter and 2.5 millimeter.

8. The backlight module according to claim 4, characterized in that: the specular reflector is a silver reflector.

9. A liquid crystal display device comprising: a liquid crystal display panel, characterized in that: the liquid crystal display device further comprises: a backlight module, and the liquid crystal display panel is connected to the backlight module, and the backlight module comprises a light guide plate and a light source, the light guide plate comprises: a light input side, a light output surface which adjoins to the light input side, and a bottom surface corresponding to the light output surface; wherein the light source comprises a light-emitting surface, the light source is disposed at one side of the light input side of the light guide plate, and the light-emitting surface of the light source is corresponding to the light input side of the light guide plate;
wherein the backlight module further comprises a specular reflector, the specular reflector is disposed between the light-emitting surface of the light source and the light input side of the light guide plate; and light beams emitted from the light-emitting surface of the light source toward an outside of the light input side of the light guide plate enter the light guide plate after being specularly reflected by the specular reflector.

10. The liquid crystal display device according to claim 9, characterized in that: the specular reflector extends along a reflecting plane, and the reflecting plane and the light input side of the light guide plate form a predetermined angle therebetween.

11. The liquid crystal display device according to claim 10, characterized in that: a coupling-light area is formed between the light-emitting surface of the light source and the light input side of the light guide plate, the specular reflector is disposed at an adjoining region of the coupling-light area and the light output surface of the light guide plate, and the reflecting plane is perpendicular to the light input side of the light guide plate, wherein the predetermined angle is a right angle.

12. The liquid crystal display device according to claim 9, characterized in that: the light-emitting surface of the light source and the light input side of the light guide plate have a coupling-light distance therebetween, and the coupling-light distance is ranged within a coupling-light range between 0.1 millimeter and 2.5 millimeter.

13. The liquid crystal display according to claim 9, characterized in that: the specular reflector is a silver reflector.
